(19) United States
(12) Patent Application Publication
(10) Pub. No.: US 2012/0323627 A1
(43) Pub. Date: Dec. 20, 2012

(54) Real-time Monitoring of Public Sentiment

(75) Inventors: Russell Allen Herring, JR., Sammamish, WA (US); James H. Lewallen, Fall City, WA (US); Todd D. Newman, Mercer Island, WA (US); David S. Taniguchi, Kirkland, WA (US); Lili Cheng, Bellevue, WA (US)

(73) Assignee: MICROSOFT CORPORATION, Redmond, WA (US)

(21) Appl. No.: 13/160,017

(22) Filed: Jun. 14, 2011

(51) Int. Cl. G06Q 10/00

(52) U.S. Cl. 705/7.29

(57) ABSTRACT

The subject disclosure is directed towards a real-time or near real-time sentiment monitoring service. A set of rules such as keywords and data sources to crawl is provided to the monitoring service, which crawls the sources to obtain sentiment-related data for an entity, such as a corporation or product. Content items may be selected from the crawled data, and/or the data may be analyzed to provide results. The results may be displayed, such as on a content page, to quickly view the public's sentiment regarding the entity. The rules may be dynamically modified by a user or collaborating users to tune monitoring of the entity as desired, e.g., to obtain more relevant results.

### BACKGROUND

Entities such as large companies want to monitor the public's sentiment, or perception of their company, product, organization, or the like. For example, the general public may comment on a company in a variety of media, including social media sites, microblogs, blogs, video posting sites and a variety of other websites. By way of example, a company will likely benefit from knowing the public's current sentiment regarding a product, for example, (that is, the current “buzz”) as to whether the product is being noticed in general following a marketing campaign, whether the product is liked or disliked, and so forth. The company's overall reputation is also important to know.

Some members of the public are seen as major influencers who offer their opinions frequently and are worthy of special attention. News media personnel, experts and so on belong to this category. Some sites are forums where opinions on the company or products are discussed regularly. It is difficult to remember these numerous sites, and is very time-consuming to track and summarize them. People desire simple tools to track and summarize the public sentiment.

Companies exist that will monitor public sentiment for a fee. These services are expensive and do not offer real-time analysis or even near real-time analysis; they only report periodically and thus a lot of possibly valuable time is lost waiting on a report. Other technology is similar, e.g., needing on the order of weeks to assemble relevant data.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which sentiment is monitored by a monitoring service to provide real-time or near real-time results. A crawler is configured to communicate with one or more sources of sentiment data to obtain sentiment-related data based upon rules corresponding to an entity, such as a corporation or product, as specified in a topic set including one or more keywords. A mechanism processes the sentiment-related data to provide real-time or near real-time results corresponding to the rules, in which the rules are dynamically modifiable, e.g., to add a keyword, block a keyword and/or specify a source for subsequent crawls; note that the rules may specify the one or more sources, e.g., a social network, search engine criteria, and/or an RSS feed.

The mechanism that processes the sentiment-related data may be a selection mechanism that ranks and/or filters the sentiment-related data to provide content items as the real-time or near real-time results. The ranking and/or filtering may be based upon one or more attributes including topic, content, keyword data and/or source. The mechanism that processes the sentiment-related data may be an analysis mechanism that performs a data analysis on at least some of the sentiment-related data to provide the real-time or near real-time results, e.g., as a trend analysis, sub-trend analysis, a change in volume over time, and the like.

In one aspect, an indexer may maintain the sentiment-related data in a data store for subsequent access. In general, this provides a tuned content index for each entity based on the work the users have done in tuning the crawler. The index provides a focused index of content to search regarding the entity, e.g., specifically for items in the index rather than just for sentiment purposes. A selection mechanism may rank and/or filter the maintained sentiment-related data to provide content items obtained at an earlier time.

In one aspect, the rules may be modified by various collaborating users. A user interface mechanism by which modifications to the rules are auditable, including to view a history of a modification, and to undo a modification, may be provided.

In one aspect, a dynamically modifiable topic set corresponding to an entity to monitor for sentiment data is received, in which the topic set includes one or more terms to include and zero or more blocking terms, along with information corresponding to a set of data sources to crawl for sentiment data. The topic set and the set of data sources are provided to a sentiment monitoring service to receive real-time or near real-time results comprising sentiment-related data obtained from the set of data sources. At least part of the topic set may be provided by an automated process, e.g., that detects a term in other sentiment-related data and/or extracts a term from at least one database or website. Part of the topic set may be received from user selection based upon a suggestion from an automated process.

Results from the monitoring may be received as a selected subset of items in response to providing the topic set and the set of data sources to the sentiment monitoring service. Visible data corresponding to at least some of the subset of items may be output, e.g., as a content page, which may include visibly emphasizing an item based upon an attribute associated with that item. Results from the monitoring may be received as information corresponding to a trend analysis, sub-trend analysis, or volume change over time in response to providing the topic set and the set of data sources to the sentiment monitoring service. Visible data corresponding to at least some of the information may be output as analysis results.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing an example sentiment monitoring system, including a service that a client accesses to obtain content crawled from various sources.

FIG. 2 is a representation of a user interface content page displaying sentiment results in the form of selected items returned for a specified topic set.

FIG. 3 is a representation of a user interface mechanism by which users may contribute in the way of search terms, sources and the like to modify (e.g., “tune”) the sentiment monitoring system for a given topic set for which sentiment is being monitored.

FIG. 4 is a representation of a user interface mechanism by which users may audit and undo contributions of other users to tune the sentiment monitoring system.

FIG. 5 is flow diagram showing example steps that may be taken to obtain real-time/near real-time results from a sentiment monitoring system.

FIG. 6 is a block diagram representing exemplary non-limiting networked environments in which various embodiments described herein can be implemented.

FIG. 7 is a block diagram representing an exemplary non-limiting computing system or operating environment in which one or more aspects of various embodiments described herein can be implemented.

### DETAILED DESCRIPTION

Various aspects of the technology described herein are generally directed towards real-time (or near real-time) monitoring of public sentiment with regard to a chosen entity, e.g., a corporation or similar enterprise, a group within an enterprise, a product, an individual, and so forth, (or possibly a combination thereof). In general, users specify a topic set comprising one or more topics. The technology retrieves sentiment-related data regarding the topic set, and in one implementation outputs a representative sampling of the data and/or a quantitative analysis of the data. Sources of sentiment data include social media streams, real-time news streams, Internet newsgroups, discussion forums, and real-time search engines. The selection of sentiment items may be based on attributes such as the topic, content, keywords (including phrases), and/or source (e.g., sender).

The topic set (corresponding to rules) is dynamically modifiable at any time, e.g., between crawls or possibly even during a crawl, whereby users are able to contribute topics and take other actions (e.g., block certain keywords), and thereby tune the technology to retrieve more and more relevant sentiment data over time. Machine learning may be used to select or suggest topics. Further, there is provided real-time adjustment of analysis parameters and the like, referred to as collaborative curation, whereby a team can collectively attempt to optimize the sentiment stream and/or share the analysis information.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data processing in general.

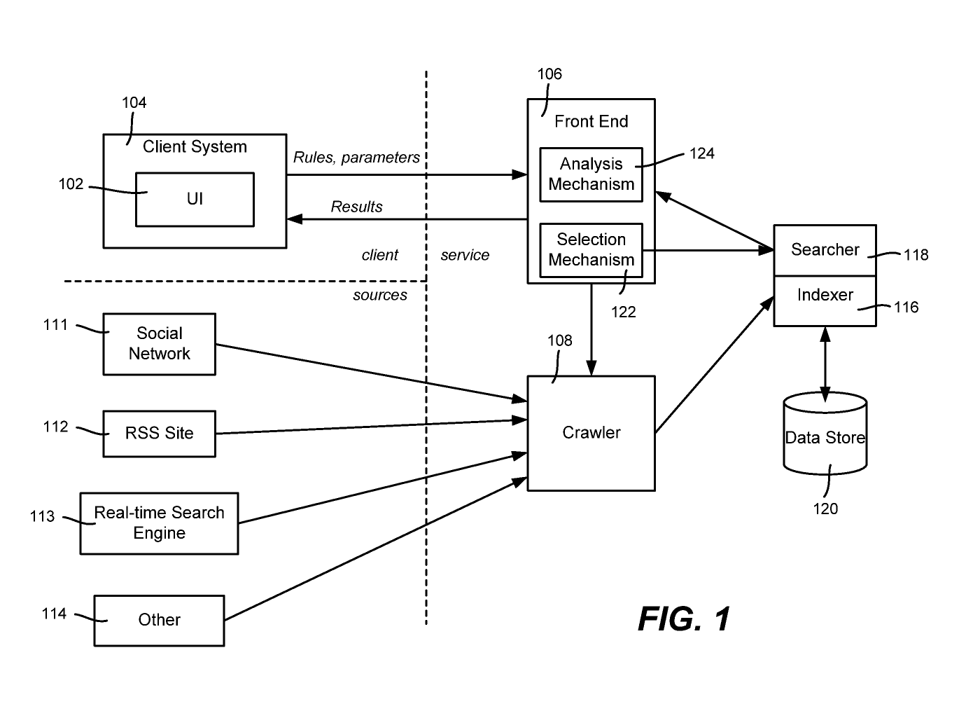

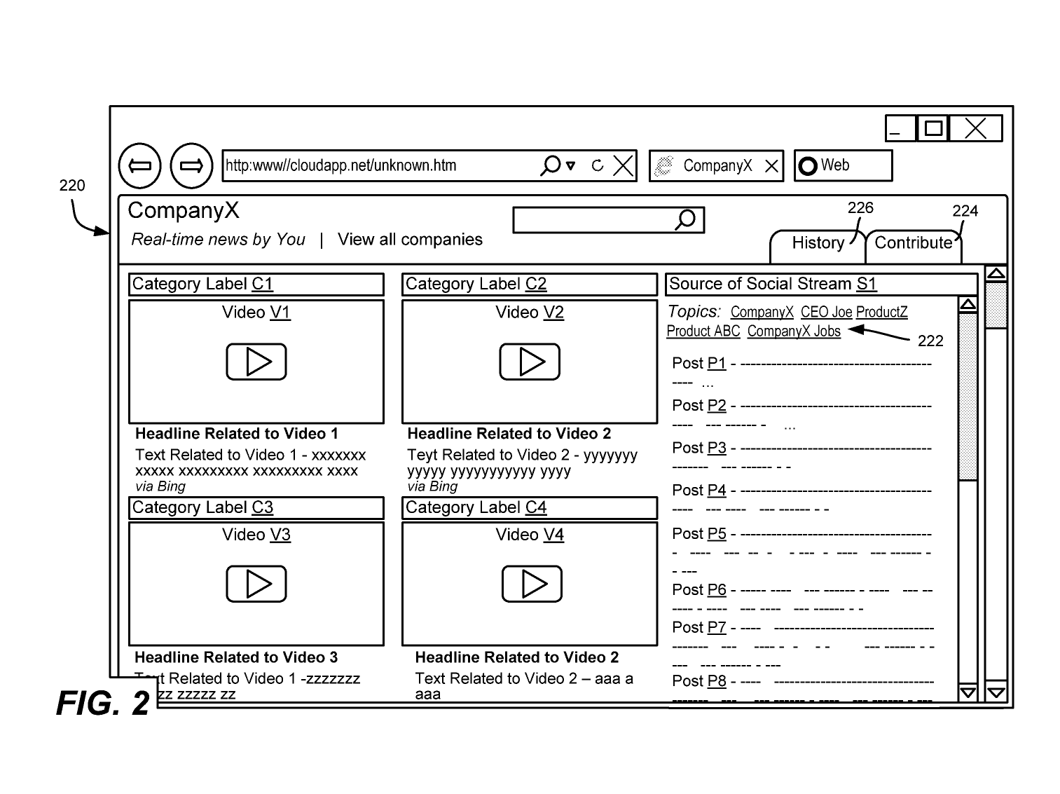

FIG. 1 is a block diagram showing example components in one implementation. A user interface (UI) 102, such as represented in part in FIGS. 2-4, is displayed on a client system 104. Users use the client system 104 (which may be one or more client machines) to enter search terms, refine them, and view the representative results and analysis information.

The interaction between the client system's user interface 102 and the service part of the system is mediated by a front end component 106. The front end component 106 aggregates various search criteria, including search terms, blocked terms, and other provided data such as people to follow, people to exclude, specified RSS sites and so forth, and converts these criteria into rules provided to a crawler 108.

The crawler 108 sends requests based upon the rules (after formatting if needed) to the appropriate sentiment sources 111-114 and passes their responses back to an indexer 116. Example sources include one or more social network sites 111, one or more RSS feed sites 112, a real-time search engine 113, and “other” 114 comprising any other source that is appropriate. One example of another source is internal enterprise data such as email; a company has rights to review its own email, and can determine the sentiment regarding what its own employees and other users currently is with respect to a topic set. Another source is internal entity (e.g., enterprise) data such as internal web site content, shared documents and the like.

The crawler 108 determines an appropriate schedule for repeated crawls for practical reasons, e.g., to assure that data stays relatively current while avoiding excessive network traffic, (although an on-demand crawl may be requested by a user). Thus, “real-time” and “near real-time” as used herein are subject to the ability of the components including the crawler 108 and the crawler's schedule to obtain, process and present relevant data; in general, this is far more rapid than existing technology, e.g., on the order of minutes, hours or even a day, rather than a week or more.

Data is indexed per company (or other entity) by the indexer 116 and stored in an appropriate format, e.g., indexed per term. Data is then retrieved by the searcher 118, where it may be analyzed by the front end 106 and then passed to the client system for display. For example, the indexer 116 may store significantly more data than any one user may want to see; the searcher 118 may filter this data as requested by different users. The indexer 116 may index/store any of the sentiment-related data, including indexed references to the source document from which the sentiment was derived.

In one implementation, a searchable full-text data store 120 is maintained that allows users to look for longer term trends in sentiment for arbitrary terms. That is, the user can search for terms, including those that were not originally used to create the sentiment data store 120. For example, a search term such as “Xbox” may be used to collect data over a period of time; although the term “Kinect” was not used to collect the data, it may be searched because it is almost certainly present in the data store 120 because of its close association with Xbox® (note that trademark references were intentionally left off of Xbox® and Kinect™ when used above as search terms, because users are likely to search only with the alphabetic characters).

In one implementation, the index 116 indexes data per search term, and provides the ability to visualize the term in real-time. Machine learning based upon the indexed data can also determine “seeds”/sources (e.g., to crawl a reference website) to derive or suggest search terms to add or block, determine a ranking of seeds and/or content to use, perform clustering of seeds, and so forth. Note that indexed data may be combined with crawled data (e.g., if not indexed), and multiple indexes may be combined to select items for returning and/or analyzing.

In an alternative implementation, the search results may be only temporarily accessible in storage, such as for instances where searching over longer periods of time is not needed. In such a situation, the indexer/searcher may be replaced with a caching system (e.g., non-volatile storage or storage that is soon overwritten).

It should be noted that the technology is not limited to gathering only sentiment-related data. In an alternative embodiment, the system may be used within an organization of sufficient size that members cannot easily converse with all other members. In this embodiment, the sources of public sentiment may be internal email, newsgroups, web-sites, content collection (e.g., SharePoint® sites), and so forth. The same analysis and processing described herein may be used, with only the sources of public sentiment information may be changed.

In one implementation, sentiment information is returned to users in the form of a web page or the like that may be rendered on a browser. As can be readily appreciated, other ways of presenting the information, and/or different page formats may be used; the following is only one non-limiting example.

FIG. 2 is a representation of an example screenshot of such a page 220. In this example, the left side of the page 220 contains videos V1-V4, with accompanying category labels C1-C4; the presented content is thus separated by categories, which, for example, may correspond to one of the topics 222. Text, links, and so forth may appear below each video V1-V4; note that content other than video may appear under a category, e.g., written articles, audio recordings and so forth.

In this example, the right side of the page 220 contains a stream of posts (e.g., P1-P8), which may be from one source, or aggregated from a plurality of sources. Posts may be in the form of a time-ordered stream from one or more social-sources, through which a user can scroll to review what is being said about the entity corresponding to the topic set. The posts may be the most recent relative to the current time, or from a timeframe specified by the user, e.g., to recall what the sentiment was when a predecessor product was released. Note that links in the posts may be used to obtain the video and/or other content on the left side of the page 220, e.g., via queries to a search engine such as Bing™.

Posts and content may be collected based upon a particular source, such as a known expert, and/or an influential reviewer. Such posts and content may be visibly highlighted or the like to emphasize its significance to the sentiment system users. As a particular example, if a movie production company wants to see the public sentiment about its newly released movie, it may want to also see how a particularly influential movie critic's review can influence the public's sentiment. This may be time based, e.g., posts maybe reviewed and content retrieved before and after the critic's review is published, to analyze the before and after data.

With respect to posts and other content, a weighting function may be used to select (e.g., via a selection mechanism 122, FIG. 1) what to output on the page and/or use in analysis (e.g., via an analysis mechanism 124, FIG. 1). For example, instead of only the most recent time-based posts, content may be weighted by time as one possible attribute (e.g., content loses weight as it ages), along with other attributes, such as the source/sender, a relevance ranking (e.g., based upon the weight/frequency of keywords), and so forth.

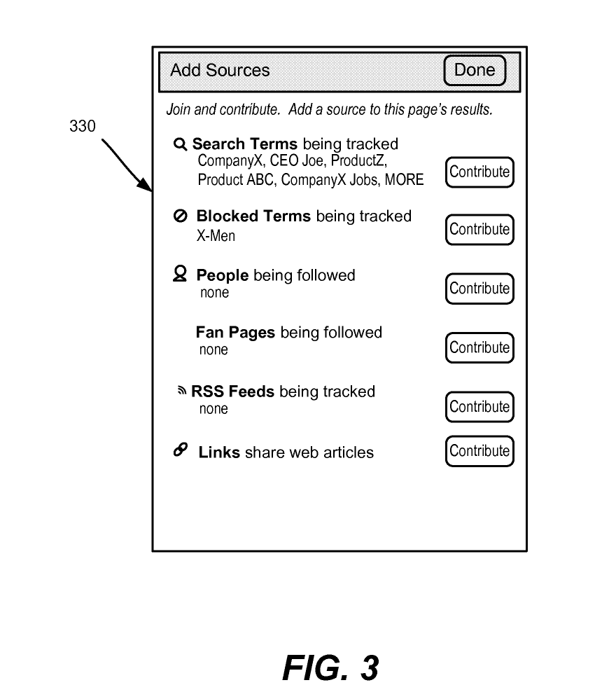

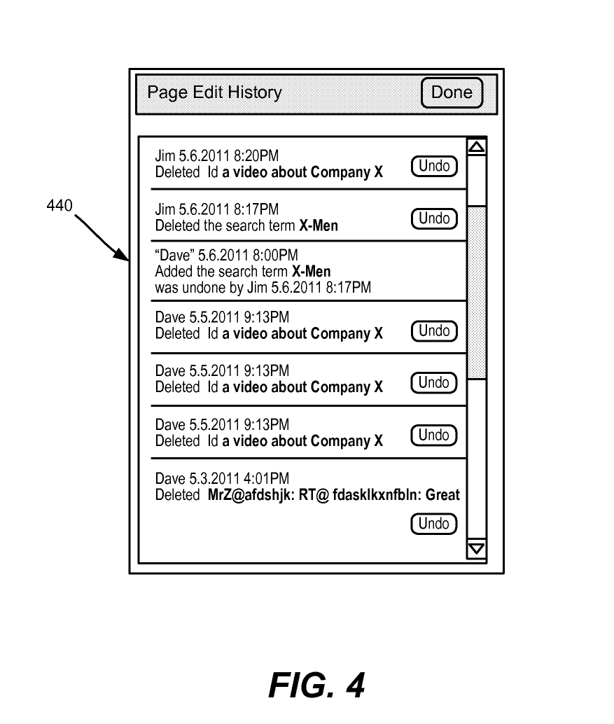

Via tabs 224 and 226 or the like, a user can contribute topics and perform other actions related to the content collection of the content, and review the history of the contributions, as represented in FIGS. 3 and 4 respectively. For example, the user interface 330 of FIG. 3 may appear when the tab 224 is clicked, which gives a user the ability to modify the set of rules or the like given to the front end 106/crawler 108 (FIG. 1) for the purposes of collecting the sentiment data. As can be seen, a user may interact to add search a term or terms, block a term or terms, specify that a certain person or people (e.g., an expert) be followed, specify fan pages, RSS feeds and links. In this way, one or more users may tune the system to refine the rules to provide what is basically a customized sentiment search engine. Because multiple users may contribute, the system allows for collaboration (collaborative curation) to tune the rules.

In addition to be able to contribute, users (or at least an authoritative person or persons) are also able to review (and take action with respect to) a history of what has occurred, corresponding to tab 226 of FIG. 2, and FIG. 4. For example, the user interface 440 of FIG. 4 may appear when the tab 226 is clicked, which gives a user the ability to audit what has taken place with respect to contributions, and undo any of them.

By way of example, consider that an inexperienced or controversial user is adding content and/or sources, adding terms and/or blocking terms so as to tune the system to support his or her personal point of view. Another user may review the history and undo such changes.

In one aspect, there may be different levels of users, which may correspond to a weight or the like. For example, one user may have the ability to make a change, while another may only vote for a change. Such weighted votes may be used to allow making a change based upon weight, such as to change another, low weight user's contribution, or to change a contribution with a larger associated weight if enough cumulative weight (including votes from other users) is present. A simple thumbs-up or thumbs-down scheme may be used to collect votes, with possibly different weights associated with different voters based upon reputation, skill level, experience, expertise and so on.

The set of users authorized to modify the system may be limited according to one or more criteria, e.g., fixed criteria. For example, instead of allowing users in general to make changes, criteria such as including an access list may limit the system such that only certain users can make changes. One example scenario is a news company having a page around a political issue or a politician, which people in general may tune to create a very biased page. If restricted, e.g., such that only employees of the company can change the criteria or vote off articles, then the system may be kept unbiased, yet not dependent upon a single editor to keep the page up to date.

As mentioned above, the system is able to be tuned to find more relevant sentiment data, e.g., improve the stream. In addition to users, automated processes may use entity extraction concepts or the like to find terms, e.g., by detecting common or interesting terms in the stream and adding (or suggesting) them as search terms, and/or adding (or suggesting) other common terms as restricted terms to block. Another way of automatically obtaining terms is to use the current search terms to access public databases and websites and extract additional relevant search terms (e.g., look up a company in a reference website and the company's web page to determine what other search terms are beneficial to include, or block).

The inclusion or restriction of each extracted term may be automatic or suggested and thereby user-directed, with users able to override any automatic action. A user interface may be provided for users to see potential items, and by selecting for inclusion or exclusion, affect the inclusion and exclusion search terms used to determine the future result stream. A user may also contextually block a term (e.g., a keyword used frequently in spam for a given company).

With respect to the indexed and/or returned data, the system is able to process the data in various ways, such as to remove duplicates or near duplicates and thereby provide a form of data compression; counts may be kept to signify detected duplicates, so that a significant number of near duplicate posts are not overlooked by the reviewer because only a representative sample is kept. Other processing includes applying a set of common rules across multiple topic sets to reduce or remove uninteresting items, such as filtering out location check-ins, items for sale, objectionable language, and so forth.

Turning to output of the sentiment, in addition to providing a summary page, a user may specify content that is to be in the results, e.g., by pinning the content. For example, for a topic set, a pinned video may be returned for showing, followed by a structured result set back to the UI.

Further, data analysis may be performed on the processed stream. Examples include trend analysis, including sub-trends. The analysis may be directed towards detecting a change in volume over time, e.g., for an entity in general, or for a particular search term. Analysis may be based upon removing original search terms from candidate trends. The analysis may show or provide links to relevant articles for trend items. Natural language processing and computational linguistics to perform automated sentiment analysis on items, e.g., whether posts about a newly-related product are mostly negative or positive may be determined automatically by processing the words in the posts.

Analytics may be done on the whole data stream or a larger subset thereof, instead of on the selected data, e.g., that appears on the screen. This may be used to model of how the object types (e.g., companies, schools) are ranked, with updated analytics based on the type of object, e.g., companies have CEOs, schools have rankings, and so forth.

In another aspect, the user interface may provide a preview of what the results will look like if a given change was made, e.g., if a term was added, removed or block, if a person was specified, and so on. This may be done by using already indexed data, or by an independent crawl (or partial crawl) that does not change what other users see unless and until committed as an actual change. As with actual results, the preview results may provide a front dash panel showing status updates for a set of topics, such as companies, with highlighting for significant stream contributors (the influencers). The preview may similarly automatically suggest sources for new pages, such as based on knowledge about companies and industries or other domain-specific expertise.

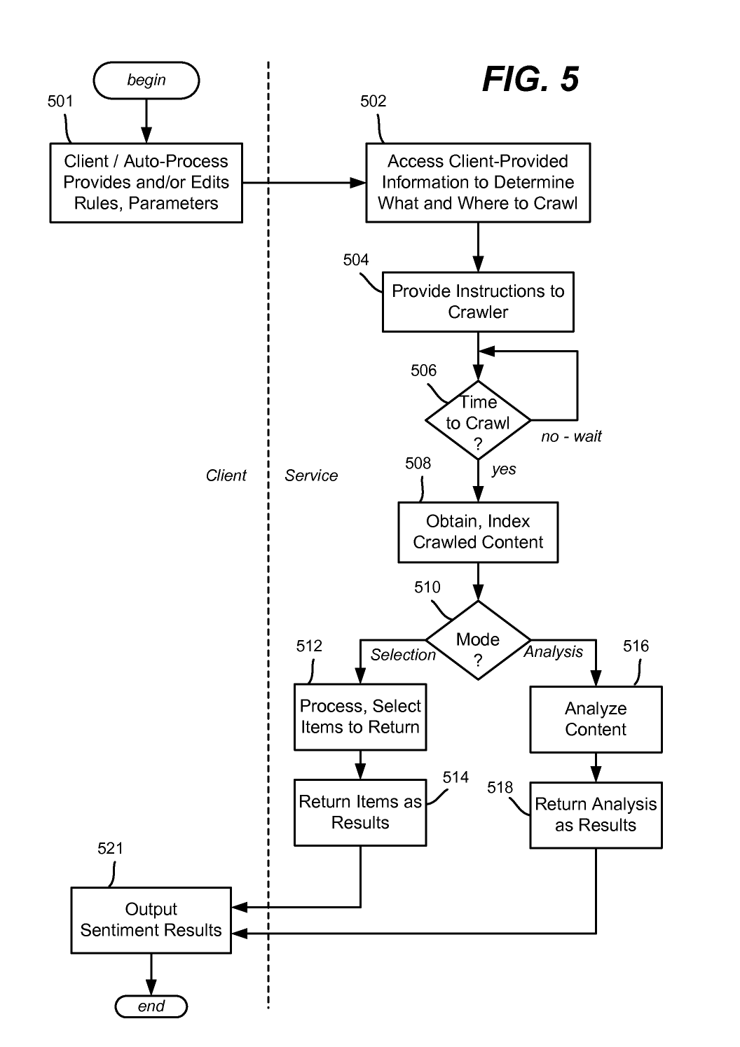

By way of summary, FIG. 5 shows example client-side (left) and service-side (right) steps with respect to a system for real-time monitoring of public sentiment with regard to a chosen entity. At step 501, the user and/or an automated machine process provides and/or edits the rules that will be used to obtain sentiment content, including the keywords in the topic set, keywords to block, the sources to crawl, and so forth.

Step 502 represents accessing the rules at the service, to determine what and where to crawl, e.g., to determine the instructions to provide to the crawler (step 504). This access may be performed at a later time, or on demand. Various parameters such as whether to return items and if so how many of each type, whether to perform an analysis (and what kind of analysis, e.g., trend and/or rate of change) and return results, and so on may be provided with the information provided to the service front end component. Note that in an alternative set of example steps, the parameters or the like may be used to specify that instead of crawling to obtain the content, already-indexed content be obtained, e.g., dating back to a particular timeframe.

Step 506 represents the crawler waiting until the scheduled time (which may be right away if on demand), at which the crawler (step 508) obtains the corresponding content and the indexer indexes it. Note that the schedule may vary for different types of content, e.g., content that takes a long time to retrieve and/or process (e.g., rank) may be crawled before other content that is rapidly retrieved/processed.

Step 510 represents determining the mode for processing the results, e.g., selection of items for returning, or analysis of the content for a report, graph and so forth. If items are to be selected, the selection mechanism 122/searcher 118 (FIG. 1) performs filtering, ranking and so forth at step 512, after which the selected items are returned at step 514. The selection may be based upon attributes such as the topic, content, keywords, and/or sender, which may be a weighted combination of each.

If an analysis is to be performed, the analysis mechanism 124 (FIG. 1) performs the analysis at step 516, after which the results are returned at step 518. Note that analysis may be after selection (filtering, ranking, and so forth), and alternatively may be performed at the client. Also note that it is feasible to provide both selected items and analysis results. Step 521 represents the client outputting the results, e.g., a page of items, or analysis results such as a graph, chart, summary data page or the like.

Thus, based on a user-specified and/or machine-specified dynamically modifiable topic set, the system provides selected items (e.g., a representative sampling of the sentiment data) and/or a quantitative analysis of the sentiment data. A searchable full-text index is maintained, which, for example, allows users to look for longer term trends or the like in sentiment. Collaborative curation may be used so that a team can collective optimize the sentiment stream and/or share the analysis information.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

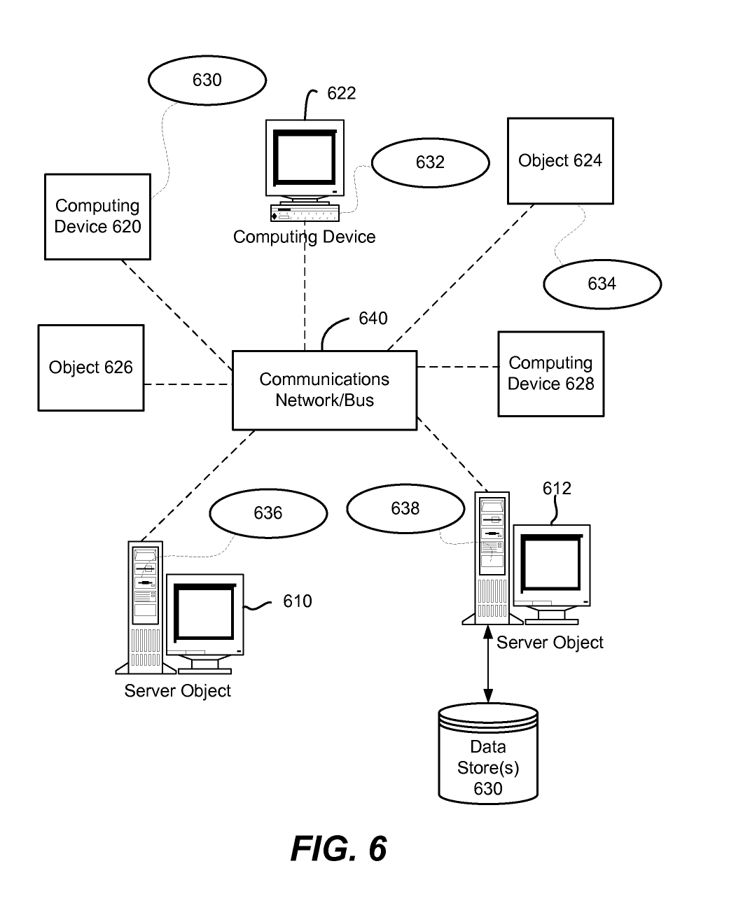

FIG. 6 provides a schematic diagram of an exemplary networked or distributed computing environment. The distributed computing environment comprises computing objects 610, 612, etc., and computing objects or devices 620, 622, 624, 626, 628, etc., which may include programs, methods, data stores, programmable logic, etc. as represented by example applications 630, 632, 634, 636, 638. It can be appreciated that computing objects 610, 612, etc. and computing objects or devices 620, 622, 624, 626, 628, etc. may comprise different devices, such as personal digital assistants (PDAs), audio/video devices, mobile phones, MP3 players, personal computers, laptops, etc.

Each computing object 610, 612, etc. and computing objects or devices 620, 622, 624, 626, 628, etc. can communicate with one or more other computing objects 610, 612, etc. and computing objects or devices 620, 622, 624, 626, 628, etc. by way of the communications network 640, either directly or indirectly. Even though illustrated as a single element in FIG. 6, communications network 640 may comprise other computing objects and computing devices that provide services to the system of FIG. 6, and/or may represent multiple interconnected networks, which are not shown. Each computing object 610, 612, etc. or computing object or device 620, 622, 624, 626, 628, etc. can also contain an application, such as applications 630, 632, 634, 636, 638, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects 610, 612, etc. can be thought of as servers where computing objects 610, 612, etc., acting as servers provide data services, such as receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 640 or bus is the Internet, for example, the computing objects 610, 612, etc. can be Web servers with which other computing objects or devices 620, 622, 624, 626, 628, etc. communicate via any of a number of known protocols, such as the hypertext transfer protocol (HTTP). Computing objects 610, 612, etc. acting as servers may also serve as clients, e.g., computing objects or devices 620, 622, 624, 626, 628, etc., as may be characteristic of a distributed computing environment.

### Exemplary Computing Device

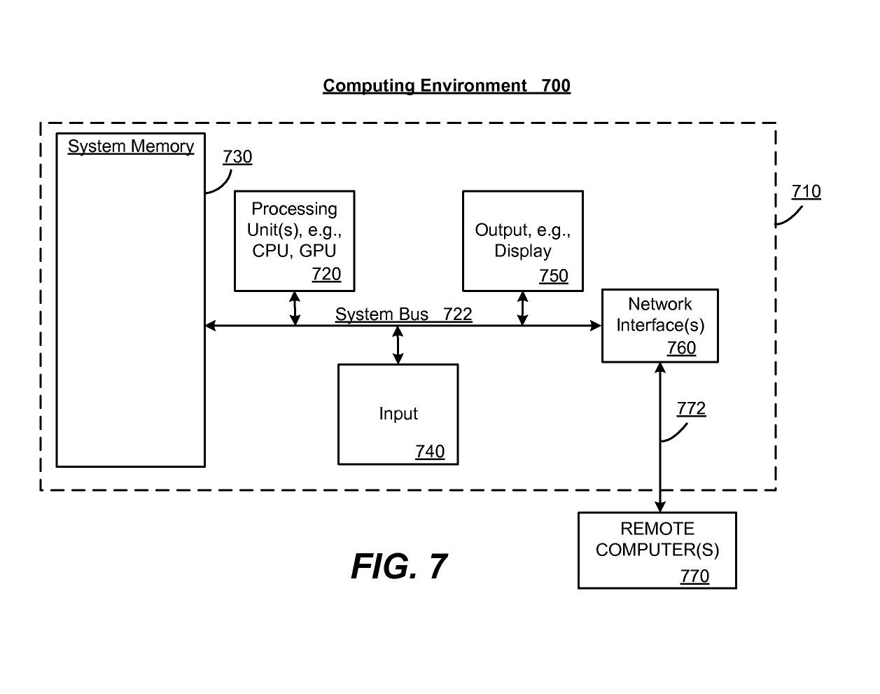

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 7 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 7 thus illustrates an example of a suitable computing system environment 700 in which one or aspects of the embodiments described herein can be implemented, although as made clear above, the computing system environment 700 is only one example of a suitable computing environment and is not intended to suggest any limitation as to scope of use or functionality. In addition, the computing system environment 700 is not intended to be interpreted as having any dependency relating to any one or combination of components illustrated in the exemplary computing system environment 700.

With reference to FIG. 7, an exemplary remote device for implementing one or more embodiments includes a general purpose computing device in the form of a computer 710. Components of computer 710 may include, but are not limited to, a processing unit 720, a system memory 730, and a system bus 722 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, system memory 730 may also include an operating system, application programs, other program modules, and program data.

A user can enter commands and information into the computer 710 through input devices 740. A monitor or other type of display device is also connected to the system bus 722 via an interface, such as output interface 750. In addition to a monitor, computers can also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 772, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a system comprising, a sentiment monitoring service, including a crawler configured to communicate with one or more sources of sentiment data to obtain sentiment-related data based upon rules corresponding to an entity, and a mechanism that processes the sentiment-related data to provide real-time or near real-time results corresponding to the rules, in which the rules are dynamically modifiable.

2. The system of claim 1 wherein the rules correspond to a topic set including one or more keywords.

3. The system of claim 1 wherein the rules specify the one or more sources, including a social network, search engine criteria, an email source, internal entity data, or an RSS feed, or any combination of a social network, search engine criteria, an email source, internal entity data, or an RSS feed.

4. The system of claim 1 wherein the mechanism that processes the sentiment-related data comprises a selection mechanism that ranks or filters, or both ranks and filters the sentiment-related data to provide content items as the real-time or near real-time results.

5. The system of claim 1 wherein the selection mechanism ranks or filters, or both ranks and filters the sentiment-related data based upon one or more attributes including topic, content, keyword data or source, or any combination thereof.

6. The system of claim 1 wherein the mechanism that processes the sentiment-related data comprises an analysis mechanism that performs a data analysis on at least some of the sentiment-related data to provide the real-time or near real-time results.

7. The system of claim 1 further comprising an indexer that maintains at least some of the sentiment-related data in a data store for subsequent access.

8. The system of claim 7 further comprising a selection mechanism configured to rank or filter, or both rank and filter maintained sentiment-related data to provide content items obtained at an earlier time.

9. The system of claim 1 wherein the rules are dynamically modifiable to add a keyword, block a keyword, or specify a source, or any combination thereof.

10. The system of claim 9 wherein a set of users authorized to modify the rules is limited according to one or more criteria.

11. The system of claim 9 further comprising a user interface mechanism by which modifications to the rules are auditable, including to view a history of a modification, and to undo a modification.

12. In a computing environment, a method performed at least in part on at least one processor, comprising, receiving a dynamically modifiable topic set corresponding to an entity to monitor for sentiment data, the topic set including one or more terms to include and zero or more blocking terms, receiving information corresponding to a set of data sources to crawl for sentiment data, and providing the topic set and the set of data sources to a sentiment monitoring service to receive real-time or near real-time results comprising sentiment-related data obtained from the set of data sources.

13. The method of claim 12 wherein receiving the dynamically modifiable topic set comprises receiving at least part of the topic set from an automated process, or receiving at least part of the topic set from user selection based upon a suggestion from an automated process, or receiving at least part of the topic set from an automated process and receiving at least part of the topic set from user selection based upon a suggestion from an automated process.

14. The method of claim 13 wherein receiving at least part of the topic set from an automated process comprises detecting a term in other sentiment-related data or extracting a term from at least one database or website, or both detecting a term in other sentiment-related data and extracting a term from at least one database or website.

15. The method of claim 12 further comprising, receiving a selected subset of items in response to providing the topic set and the set of data sources to the sentiment monitoring service, and outputting visible data corresponding to at least some of the subset of items.

16. The method of claim 12 wherein outputting visible data corresponding to at least some of the subset of items comprises visibly emphasizing an item based upon an attribute associated with that item.

17. The method of claim 12 further comprising, receiving information corresponding to a trend analysis, sub-trend analysis, or volume change over time in response to providing the topic set and the set of data sources to the sentiment monitoring service, and outputting visible data corresponding to at least some of the information.

18. The method of claim 12 further comprising, receiving a request to access indexed data corresponding to the entity, providing information corresponding to the request to a sentiment monitoring service to receive results corresponding to sentiment-related data maintained in a data store, and returning information corresponding to the results in response to the request.

19. One or more computer-readable media having computer-executable instructions, which when executed perform steps, comprising:
monitoring for public sentiment with respect to an entity based upon rules, including crawling a plurality of sources to obtain sentiment-related data, processing the sentiment-related data to select items from among the sentiment-related data, or to perform data analysis on the sentiment-related data, or both to select items and perform data analysis;
returning results of the monitoring based upon the rules;
receiving a request to monitor for public sentiment with respect to an entity based upon modified rules;
monitoring for public sentiment with respect to an entity based upon the modified rules, including crawling a plurality of sources to obtain other sentiment-related data, processing the other sentiment-related data to other select items from among the other sentiment-related data, or to perform data analysis on the other sentiment-related data, or both to select items and perform data analysis; and
returning results of the monitoring based upon the modified rules.

20. The one or more computer-readable media of claim 19 having further computer-executable instructions comprising, indexing at least some of the sentiment-related data in a data store for subsequent access.
